(19) United States
(12) Patent Application Publication
(10) Pub. No.: US 2020/0009951 A1
(43) Pub. Date: Jan. 9, 2020

(54) SUNROOF APPARATUS

(71) Applicant: AISIN WUXI BODY PARTS CO., LTD., Jiangsu (CN)

(72) Inventor: Kazuki SAWADA, Jiangsu (CN)

(73) Assignee: AISIN WUXI BODY PARTS CO., LTD., Jiangsu (CN)

(21) Appl. No.: 16/263,346

(22) Filed: Jan. 31, 2019

(30) Foreign Application Priority Data
Jul. 9, 2018 (CN) 201821086139.2

(51) Int. Cl. B60J 7/043; B60J 7/00; B60J 7/02

(52) U.S. Cl. CPC B60J 7/043; B60J 7/022; B60J 7/0015

(57) ABSTRACT

A sunroof apparatus includes: a pair of guide rail members which are arranged on two opposite side edges in a vehicle widthwise direction of a roof opening along a vehicle front-rear direction; a movable panel; and a functional member which is configured to move along the pair of guide rail members and support the movable panel to open and close the roof opening, each guide rail member is provided with a functional member accommodating portion which accommodates the functional member and is located on an outer side of the vehicle widthwise direction with respect to the roof opening. According to the sunroof apparatus, the visual field from the sunroof in a vehicle chamber can be effectively enlarged, and water, dust or the like can be effectively prevented from invading the arrangement space of the functional member.

### TECHNICAL FIELD

The invention relates to a sunroof apparatus, and more particularly, to a sunroof apparatus for a vehicle.

### BACKGROUND

In the prior art, there is a known sunroof apparatus in which a pair of guide rails is arranged at two opposite edges in a vehicle widthwise direction of a substantially quadrangular opening formed at a roof of a vehicle, and a movable panel of the sunroof apparatus is supported to open and close the opening through movement of a functional member along the pair of guide rails. For example, the functional member is a shoe for supporting the movable panel so as to move along a front-rear direction, a bracket for supporting the movable panel so as to move obliquely, etc.

For example, the patent document 1 discloses a sunroof apparatus. Specifically, referring to FIGS. 6 and 7 of the patent document 1, the sunroof apparatus is a so-called internal sliding sunroof apparatus, which uses a pair of sliding members 31 serving as a functional member to cause a movable panel 12 to slide toward a lower side of a top cover 10 along a pair of guide rails 13 or slide in an opposite direction to open or close an opening portion 10a of the top cover. Moreover, in the sunroof apparatus, the sliding members 31 are located below the movable panel 12, and therefore accommodating portions for accommodating the sliding members 31 in the guide rails 13 are located on the inner side in the vehicle widthwise direction with respect to the opening portion 10a of the top cover.

### PRIOR ART DOCUMENT

Patent document 1: WO2013/176001

In the sunroof apparatus of the patent document 1, there is a problem that the accommodating portions for accommodating the sliding members 31 in the guide rails 13 are located on the inner side in the vehicle widthwise direction with respect to the opening portion 10a (outdoor side opening in the roof) of the top cover, and as the sunroof view on the inner side of a vehicle chamber is defined by the pair of guide rails 13, and the edge of the inner opening (an indoor side opening in the roof) of a vehicle chamber is located on the inner side in the vehicle widthwise direction with respect to the edges of the guide rails 13, when the functional member is arranged below the movable panel, the inner opening of the vehicle chamber cannot be set corresponding to the area of the movable panel, that is, the area of the indoor side opening in the roof is smaller than the area of the sunroof panel, and therefore a visual field from the sunroof in the vehicle chamber is smaller due to the smaller area of the indoor side opening.

In addition, there is a problem in the prior art that external water, dust or the like can easily invade an arrangement space of the functional member by utilizing a gap between the movable panel and the roof opening, thereby easily causing deterioration in the sliding performance of the functional member.

### SUMMARY

An object of the invention is to provide a sunroof apparatus capable of effectively expanding the visual field from the sunroof in a vehicle chamber and effectively preventing water, dust and the like from invading an arrangement space for a functional member.

A technical solution of the invention is as follows: a sunroof apparatus includes: a pair of guide rail members which are arranged on two opposite side edges in a vehicle widthwise direction of a roof opening along a vehicle front-rear direction; a movable panel which is located below the roof when the sunroof apparatus is in a fully open state; and a functional member which is configured to move along the pair of guide rail members and support the movable panel to open and close the roof opening, wherein each guide rail member is provided with a functional member accommodating portion which accommodates the functional member and is located on an outer side of the vehicle widthwise direction with respect to the roof opening.

According to the technical solution, as the functional member accommodating portion is located on an outer side in the vehicle widthwise direction with respect to the roof opening (i.e., an outdoor side opening), an indoor side opening can be enlarged correspondingly, and the visual field from the sunroof in the vehicle chamber can be effectively expanded.

In the above technical solution, preferably, the sunroof apparatus is further provided with a sunshade which is arranged below the movable panel and is movable along the pair of guide rail members, each guide rail member is provided with a sunshade holding portion which guides the sunshade to move along the guide rail member, and is configured such that a lower surface of the sunshade holding portion is located at a position higher than a lower surface of the functional member accommodating portion.

In this way, since the sunshade holding portion located on the inner side of the vehicle is arranged at a position higher than the functional member accommodating portion located on an outer side of the vehicle, the indoor side opening can be arranged by using a space formed by such height difference, and accordingly a top plate in the vehicle chamber can be arranged at a higher position, thereby effectively improving a height of the vehicle chamber.

In the above technical solution, preferably, the sunroof apparatus is further provided with a deflector, which includes: a deflector main body extending along the vehicle widthwise direction, and a deflector arm extending along the vehicle front-rear direction, each guide rail member is further provided with a drain portion, the deflector arm is arranged on the drain portion, and in each guide rail member, the functional member accommodating portion is located on an outer side in the vehicle widthwise direction with respect to the drain portion.

In this way, since the deflector arm is arranged on the drain portion, and the drain portion is arranged on the inner side with respect to the functional member accommodating portion, water, dust or the like can be effectively prevented from invading the arrangement space for the functional member by using a partition member between the drain portion and the functional member accommodating portion.

In the above technical solution, preferably, the functional member is a pair of shoes that slides along the pair of guide rail members.

In the above technical solution, preferably, the pair of shoes are connected with a panel reinforcement portion fixed to the movable panel.

### BRIEF DESCRIPTION OF THE DRAWINGS

FIG. 1 is a schematic perspective view showing a sunroof apparatus arranged on a roof.

FIG. 2 is a side view showing the sunroof apparatus of the present embodiment.

### REFERENCE SIGNS

1 sunroof apparatus
10 guide rail member
11 functional member accommodating portion
12 sunshade holding portion
15 drain portion
16 partition wall
17 deflector arm
2 roof opening
20 roof
3 movable panel
4 functional member
41 shoe
5 sunshade
7 sealing member
8 panel reinforcement portion
90 indoor side opening

### DETAILED DESCRIPTION OF THE EMBODIMENTS

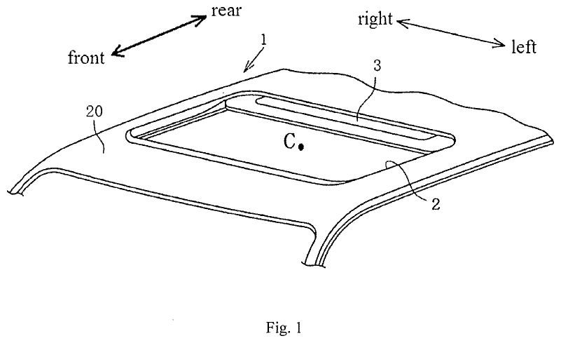

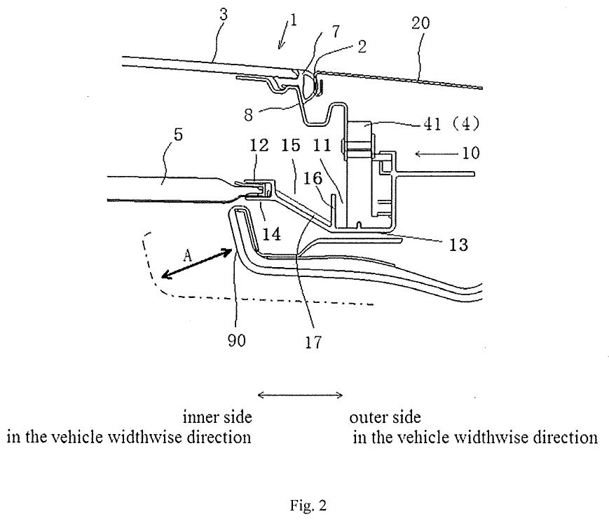

Hereinafter, the sunroof apparatus of the present embodiment will be specifically described with reference to FIGS. 1 to 2.

In FIG. 1, the “front” direction indicates a direction toward the front of a vehicle, the “rear” direction indicates a direction toward the rear of the vehicle, the “left” direction indicates a leftward direction when orienting toward the front of the vehicle, the “right” direction indicates a rightward direction when orienting toward the front of the vehicle, the “front-rear direction” corresponds to a “vehicle front-rear direction”, and the “left-right direction” corresponds to a “vehicle widthwise direction”.

In FIG. 2, the exterior-interior direction of a paper surface is the vehicle front-rear direction, the left-right direction of the paper surface is the vehicle widthwise direction, and the upper-lower direction of the paper surface is the upper-lower direction of the vehicle.

The sunroof apparatus 1 of the present embodiment includes a pair of guide rail members 10, 10; a movable panel 3; a functional member 4; a sunshade 5; and a deflector (not shown).

The pair of guide rail members 10, 10 is arranged on two opposite side edges in the vehicle widthwise direction of a roof opening 2 along a vehicle front-rear direction. The roof opening 2 is formed in a roof 20 and forms an outdoor side opening opposite to an indoor side opening 90 of the vehicle.

The movable panel 3 is a transparent panel. The sunroof apparatus 1 of the present embodiment is a so-called internal sliding sunroof apparatus in which the movable panel 3 is located below the roof 20 when the sunroof apparatus is in a fully open state, that is, when the roof opening 2 is completely opened through the movement of the movable panel 3. A sealing member 7 (weather strip) is arranged on the outer periphery of the movable panel 3 for abutting against the edge of the roof opening 2 to form a seal for preventing external water, dust or the like from invading through a gap between the movable panel 3 and the roof opening 2.

The functional member 4 is configured to move along the pair of guide rail members 10, 10 and support the movable panel 3 to open and close the roof opening 2. In the present embodiment, the functional member 4 is a pair of shoes 41, 41 sliding along the pair of guide rail members 10, 10, and the movable panel 3 can be driven to move in the vehicle front-rear direction by the pair of shoes 41, 41. A panel reinforcement portion 8 is also arranged between the shoe 41 and the movable panel 3. The panel reinforcement portion 8 is fixed to the movable panel 3, and the pair of shoes 41, 41 is connected with the panel reinforcement portion 8 to stably support the movable panel 3 during movement of the shoe 41, and by a direct connection between the pair of shoes 41, 41 and the panel reinforcement portion 8, the number of members can be reduced.

The sunshade 5 is arranged below the movable panel 3 and is movable along the pair of guide rail members 10, 10. The sunshade 5 may be a plate having a sunshade effect or a cloth material having the sunshade effect.

The deflector includes: a deflector main body (not shown) extending along the vehicle widthwise direction; and a deflector arm 17 extending along the vehicle front-rear direction. Specifically, the deflector main body is arranged in front of the vehicle with respect to the deflector arm 17 and can rotate with a rear end of the deflector arm 17 as a fulcrum. The deflector is used for rectifying air entering from the front of the vehicle in a semi-open state of the sunroof apparatus. The arrangement position of the deflector is described in detail below.

Each guide rail member 10 is provided with: a functional member accommodating portion 11; a sunshade holding portion 12; and a drain portion 15.

In each guide rail member 10, the functional member housing portion 11 is located on the outer side in the vehicle widthwise direction with respect to the drain portion 15. Specifically, in the guide rail member 10 on each side, the sunshade holding portion 12, the drain portion 15 and the functional member accommodating portion 11 are successively arranged from the inner side toward the outer side in the vehicle widthwise direction.

The functional member housing portion 11 accommodates the functional member 4, and the functional member housing portion 11 is located on the outer side of the vehicle widthwise direction with respect to the roof opening 2. That is, in the guide rail member 10 on each side, the functional member housing portion 11 is located on a side away from a center C (referring to FIG. 1) of the roof opening 2 with respect to an end surface on the vehicle inner side of the top plate of the vehicle on the corresponding side. A partition wall 16 formed between the drain portion 15 and the functional member accommodating portion 11 and serving as a partition member forms an end wall of the functional member accommodating portion 11 on the vehicle inner side of the vehicle. In the present embodiment, the partition wall 16 is configured to be located on the outer side in the vehicle widthwise direction with respect to the end surface on the vehicle inner side of the top plate of the vehicle on the corresponding side. Of course, the invention is not limited thereto, as long as most of the functional member accommodating portion 11 is located on the outer side in the vehicle widthwise direction with respect to the end surface on the vehicle inner side of the top plate of the vehicle on the corresponding side, and more specifically, as long as the functional member 4 accommodated in the functional member accommodating portion 11, for example, the shoe 41 is located on the outer side in the vehicle widthwise direction with respect to the end surface on the vehicle inner side of the top plate of the vehicle on the corresponding side.

The drain portion 15 is arranged on the vehicle inner side of the functional member accommodating portion 11 with the partition wall 16 spaced therebetween and is formed into a groove shape, and the deflector arm 17 of the deflector described above is arranged in the drain portion 15. Specifically, the deflector main body of the deflector is arranged between the drain portions 15 of the pair of guide rail members 10, 10 in the front of the vehicle, and a pair of deflector arms 17 is respectively arranged in the drain portions 15 of the guide rail members 10, 10 on both sides. Therefore, the water brought by the deflector can easily flow into the drain portion 15 and be discharged outwardly.

For example, the sunshade holding portion 12 is a groove member whose opening faces to the inner side of the vehicle and extends along the vehicle front-rear direction. The sunshade holding portion 12 guides the sunshade 5 to move along the guide rail member 10, and is configured such that a lower surface 14 of the sunshade holding portion 12 is located at a position higher than a lower surface 13 of the functional member accommodating portion 11.

Next, the specific effects of the sunroof apparatus 1 of the invention will be further described. A broken line in FIG. 2 denotes a corresponding position of a ceiling in the vehicle chamber when the functional member accommodating portion of the guide rail member in the sunroof apparatus is arranged on the vehicle inner side with respect to the roof opening as in the prior art. It can be seen from FIG. 2 that, according to the settings of the invention, with respect to the prior art, the indoor side opening 90 can be formed at a position closer to the outer side in the vehicle widthwise direction, and in this way, the size of the indoor side opening 90 in the vehicle widthwise direction can be increased, and the visual field from the sunroof indoor can be expanded. Moreover, as the lower surface 14 of the sunshade holding portion 12 is located at a position higher than the lower surface 13 of the functional member accommodating portion 11, the indoor side opening 90 having a bent portion that is bent upward can be formed by using the space formed by such height difference therebetween, and accordingly, the ceiling in the vehicle chamber is closer to the lower side of the guide rail member 10, and thus the height of the vehicle chamber can be effectively improved. As shown in FIG. 2, A in the figure denotes improvement in the height of the vehicle chamber and the size of the opening in the vehicle chamber due to the ceiling in the vehicle chamber of the present embodiment with respect to the prior art. The sunroof apparatus 1 according to the present embodiment can effectively improve the height of the vehicle chamber and the visual field from the sunroof in the vehicle chamber.

The preferred embodiment of the invention have been described above, but the invention is not limited thereto, and various variations can be made without departing from the scope of the spirit of the invention.

For example, in the above embodiment, the shoe is used as the functional member, but the invention is not limited thereto, and any member that can be accommodated in the guide rail member, move along the guide rail member and support the movable panel falls within the scope of the functional member.

In the above embodiment, the structure in which the movable panel slides toward the rear of the vehicle to open the roof opening has been described. However, the invention is not limited thereto, and a structure in which the movable panel slides toward the front of the vehicle to open the roof opening may be used.

In the above embodiment, the structure of the sunroof apparatus provided with the sunshade has been described, but the invention is not limited thereto, and the sunshade may be not provided.

In the above embodiment, the structure of the sunroof apparatus only having the movable panel has been described. However, the invention is not limited thereto, and a structure in which a transparent fixed panel is arranged at the roof, and the moving panel is located below the fixed panel when the sunroof apparatus is in the fully open state may be used.

The present embodiment has been described above with reference to a specific example. However, the invention is not limited to the specific example. A design obtained by those skilled in the art by applying a suitable design change to the specific example is also included within the scope of the invention as long as it has the features of the invention.

1: A sunroof apparatus, comprising:
a pair of guide rail members which are arranged on two opposite side edges in a vehicle widthwise direction of a roof opening along a vehicle front-rear direction;
a movable panel which is located below the roof when the sunroof apparatus is in a fully open state; and
a functional member which is configured to move along the pair of guide rail members and support the movable panel to open and close the roof opening,
wherein each guide rail member is provided with a functional member accommodating portion which accommodates the functional member and is located on an outer side of the vehicle widthwise direction with respect to the roof opening.

2: The sunroof apparatus according to claim 1, wherein
the sunroof apparatus is further provided with a sunshade which is arranged below the movable panel and is movable along the pair of guide rail members, and
each guide rail member is provided with a sunshade holding portion which guides the sunshade to move along the guide rail member, and is configured such that a lower surface of the sunshade holding portion is located at a position higher than a lower surface of the functional member accommodating portion.

3: The sunroof apparatus according to claim 1, wherein
the sunroof apparatus is further provided with a deflector which comprises a deflector main body extending along the vehicle widthwise direction, and a deflector arm extending along the vehicle front-rear direction,
each guide rail member is further provided with a drain portion, the deflector arm is arranged on the drain portion, and
in each guide rail member, the functional member accommodating portion is located on an outer side in the vehicle widthwise direction with respect to the drain portion.

4: The sunroof apparatus according to claim 1, wherein
the functional member is a pair of shoes that slide along the pair of guide rail members.

5: The sunroof apparatus according to claim 4, wherein
the pair of shoes are connected with a panel reinforcement portion fixed to the movable panel.
